(19) United States
(12) Patent Application Publication
(10) Pub. No.: US 2009/0033694 A1
(43) Pub. Date: Feb. 5, 2009

(54) PRINTER CONTROL SYSTEM AND METHOD FOR ARTIFACT FREE AND BORDERLESS PRINTING

(76) Inventors: Yang Shi, San Diego, CA (US); Richard A. Dibiase, Rochester, NY (US); Christopher Rueby, North Chili, NY (US); Yu Chen, San Diego, CA (US)

Correspondence Address: David A. Novais, Patent Legal Staff;Eastman Kodak Company, 343 State Street, Rochester, NY, 14650-2201, US

(21) Appl. No.: 11/831,081

(22) Filed: Jul. 31, 2007

(51) Int. Cl. B41J 29/38

(52) U.S. Cl. 347/9

(57) ABSTRACT

A system and a method for improving the quality of prints using a print mask for a printer having at least one printhead with a plurality of dot forming elements arranged in complementary dot forming element groups by section to prevent artifacts by compensating for bad dot forming elements on a print head. The method including the steps of identifying each bad dot forming element, identifying and setting up a threshold for each complementary dot forming element group corresponding to one or more bad dot forming elements, and creating a compensation print mask having one or more intermediate print sections by reassigning printing duty cycle from the bad dot forming elements to their respective complementary dot forming elements before printing using the compensation print mask.

### FIELD OF THE INVENTION

The invention relates generally to the field of swath-type printing, such as inkjet printing, and more particularly to a print mask method and controller to compensate for failed inkjet nozzles, and particularly near the edge of the image receiver.

### BACKGROUND OF THE INVENTION

Inkjet printing is a non-impact method for producing images by the deposition of ink droplets in a pixel-by-pixel manner onto an image-recording element in response to digital signals. There are various methods that may be utilized to control the deposition of ink droplets on the receiver member to yield the desired image. In one process, known as drop-on-demand inkjet printing, individual droplets are ejected as needed onto the recording medium to form the desired image. Common methods of controlling the ejection of ink droplets in drop-on-demand printing include piezoelectric transducers and thermal bubble formation using heated actuators. With regard to heated actuators, a heater placed at a convenient location within the nozzle or at the nozzle opening heatsink in the nozzle to form a vapor bubble that causes a drop to be ejected to the recording medium in accordance with image data. With respect to piezoelectric actuators, piezoelectric material is used in conjunction with each nozzle and this material possesses the property such that an electrical field when applied thereto induces mechanical stresses therein causing a drop to be selectively ejected from the nozzle selected for actuation. The image data provides signals to the printhead determining which of the nozzles are to be selected for ejecting an ink drop, such that each nozzle ejects an ink drop at a specific pixel location on a receiver sheet.

In another process, known as continuous inkjet printing, a continuous stream of droplets is discharged from each nozzle and deflected in an image-wise controlled manner onto respective pixel locations on the surface of the recording member, while some droplets are selectively caught and prevented from reaching the recording member. Inkjet printers have found broad applications across markets ranging from the desktop document and pictorial imaging to short run printing and industrial labeling.

A typical inkjet printer produces an image by ejecting small drops of ink from the printhead containing a spatial array of nozzles, and the ink drops land oil a receiver medium, (typically paper, coated paper, etc. and referred to generically here as paper or page or media) at selected pixel locations to form round ink dots. Normally, the drops are deposited with their respective dot centers determined by a rectilinear grid, i.e. a raster, with equal spacing in the horizontal and vertical directions. The inkjet printers may have the capability to either produce dots of the same size or of variable size. Inkjet printers with the latter capability are referred to as multitone or gray scale inkjet printers because they can produce multiple density tones at each selected pixel location on the page.

Inkjet printers may also be distinguished as being either pagewidth printers or swath printers. Examples of pagewidth printers are described in U.S. Pat. Nos. 6,364,451 B1 and 6,454,378 B1. As noted in these patents, the term “pagewidth printhead” refers to a printhead having a printing zone that prints one line at a time on a page, the line being parallel either to a longer edge or a shorter edge of the page. The line is printed as a whole as the page moves past the printhead and the printhead is typically stationary, i.e. it does not transverse the page. These printheads are characterized by having a very large number of nozzles. The referenced U.S. patents disclose that should any of the nozzles of one printhead be defective the printer may include a second printhead that is provided so that selected nozzles of the second printhead substitute for defective nozzles of the primary printhead.

A swath printer uses a printhead having a plurality of nozzles disposed in an array in one or more rows, such that the length of the array is somewhat less than the height of the page. The multiple rows can be nozzles for ejecting different ink colors or different droplet sizes. Multiple rows are also used to increase the effective nozzle density for printing by staggering the rows of nozzles along the length of the array. Because the array length is less than the height of a page, printing is done in swaths having a height, which is equal to or less than the array length. A swath is printed as the printhead traverses across a page to be printed in a traversal direction, which is substantially perpendicular to the array length. The printhead traversal direction is also referred to as the fast scan direction. After the swath is completed, the paper is advanced along a paper movement axis, which is perpendicular to the printhead traversal direction. The paper movement axis is also called the slow scan direction. The distance of paper advance is set to be less than or equal to the swath height in order to allow every pixel location on the page to be printed in successive swaths. For fastest printing throughput, all pixels to be printed in the region traversed by the printhead are printed during a single pass, and the page advance is set to the swath height. However, in many applications it is found that print quality is improved if a subset of pixels is printed in each pass, and multiple passes are used to print each region. In multi-pass printing, the page advance distance is set to be less than the swath height.

There are many techniques present in the prior art that describe methods of controlling the printer including “print masking.” The term “print masking” generally refers to printing subsets of the image pixels in multiple passes of the printhead relative to a receiver medium. The print mask indicates which pixels have permission to be printed during a given pass of the printhead.

When printing on a cut-sheet inkjet printer, the paper is held by (at least) two sets of rollers. The first set is made up of a long main roller below the paper and one or more rollers above. The upper rollers are tensioned against the lower roller and are free turning. The lower roller is driven to advance the paper. The second set of rollers has a long main roller below the paper and one or more star wheels above the paper. The star wheels are tensioned against the lower roller and are free turning. The second upper set are star shaped to minimize contact with the freshly printed paper surface and to avoid smearing the ink.

As the paper is fed through the printer, it starts out held by only the first roller set. In this portion of the printing process, the paper may curl up or down, changing the head/paper spacing, which changes dot alignment. Part way into the print, the paper will start being held by the star wheel rollers also. This middle area of the print is the most stable for paper advance and head/paper spacing since the paper is held by both sets of rollers. Then, at the end of the print, the paper comes out of the first roller and is only held by the star wheel rollers. At this point, paper curl could change the head/paper spacing. Also, the paper advance distances may not be as accurate when the star wheel rollers only hold the paper. Additionally the area near the edges or borders is not effectively printed.

It is also known in inkjet printing that individual nozzles can fail to eject drops when commanded, due to a variety of reasons including electrical failure, clogging with fibers or contaminants in the ink, drying out, and others. When a nozzle fails, an unprinted streak appears in the image, causing an undesirable image artifact. Multipass printing in which the page is advanced by less than the swath height provides a means for allowing more than one nozzle to print a given line, thereby minimizing the appearance of the failed nozzle since not all dots in the given line will be missing. Additionally, it is known in the art to redirect the printing duty of the failed nozzle to another nozzle that prints along the same line, so that the unprinted locations are minimized or eliminated, thereby “correcting” for the failed nozzle. However, prior art techniques for failed nozzle correction generally do not sufficiently address the problem of providing for failed nozzle collection in borderless regions of the print, where the paper is not engaged by both sets of rollers.

This system and related method makes artifact free and borderless printing possible by allowing the printhead to print up to the paper edge and thus effectively give complete coverage for the printhead on a sheet of paper and/or receiver, even for the case of failed nozzles.

### SUMMARY OF THE INVENTION

In accordance with an object of the invention, both a system and a method are provided for improving the quality of prints using a print mask to prevent artifacts by compensating for bad dot forming elements on a print head supporting a plurality of dot forming elements arranged in complementary dot forming element groups by section. The method including the steps of identifying each bad dot forming element, identifying and setting up a threshold for each complementary dot forming element group corresponding to one or more bad dot forming elements, and creating a compensation print mask having one or more intermediate print sections by using a blue noise matrix and the thresholds for the complementary dot forming elements to reassign printing duty cycle from the bad dot forming elements to their respective complementary dot forming elements before printing using the compensation print mask. This may be applied multiple times as needed.

### BRIEF DESCRIPTION OF THE DRAWINGS

FIG. 1A shows a printer with the leading end of the paper held by one set of rollers.

FIG. 1B shows a printer with the paper being held by both sets of rollers.

FIG. 1C shows a printer with the trailing end of the paper held by one set of rollers.

FIG. 2 is a schematic illustrating the control features on an inkjet printer.

FIG. 3 illustrates an exemplary mask for normal multipass printing.

FIG. 4 illustrates the mask of FIG. 3 with the mask data shown in the corresponding printhead nozzle locations.

FIG. 5 is a flowchart illustrating a method of the present invention as applied in general, and also in particular for borderless printing.

FIG. 6 illustrates a method of the present invention in which duty cycle is redistributed from a failed nozzle to its complementary nozzles with the aid of a blue noise matrix.

FIG. 7 is a flowchart illustrating a method of the present invention, as applied in general, and also in particular for borderless printing.

### DETAILED DESCRIPTION OF THE INVENTION

The present description will be directed in particular to elements forming part of, or cooperating more directly with, apparatus and methods in accordance with the present invention. It is to be understood that elements not specifically shown or described may take various forms well known to those skilled in the art.

In the specification, various terms are employed and are defined as discussed above and summarized below as follows:

The term “print mask” is related to the controls that are used to give permission to print, referring to the dot forming elements, including nozzles, and including an image-independent matrix determining which printing element (nozzle) should be used for each potential dot location on a receiver. A print mask can be used for multi-pass, multi-drop and multi-channel (which includes color or other printable materials) situations.

The term “dot forming elements” refers to any of the myriad of ways, including the nozzles of an inkjet printer, that a dot may be formed on a recording medium.

The term “print mode” refers to the set of instructions relative to one mask matrix (width×height), the number of passes, and the maximum number of drops per pixel. If any of these parameters change then it is a mode change.

For one of the contiguous sections of nozzles that compose the mask (see the following descriptions and associated drawings), the height of the mask section is determined by taking the total mask height (in number of nozzles) and dividing by total number of passes for that particular mode

∴section height size=mask height/# passes

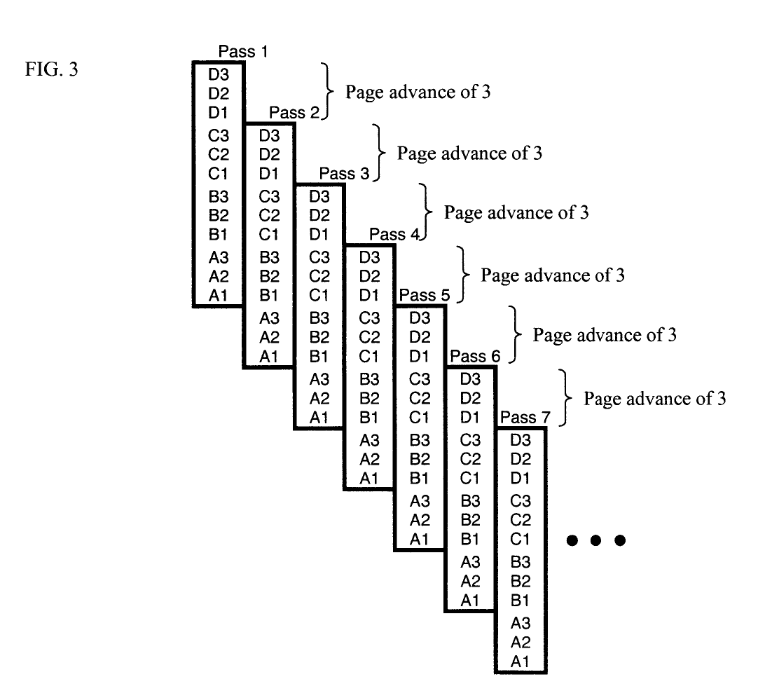

The term “complementary nozzles” refers to a set of nozzles, one from each mask section, each of which will have the capability of printing pixels on the same line of the output print as the media is advanced for each successive print swath. Complementary nozzles line up with each other on any given line of the printed output as is illustrated below in FIG. 3 where there are three sets of complementary nozzles:

Set 1: Mask positions A1, B1, C1, D1 [those for the first line to be printed]
Set 2: Mask positions A2, B2, C2, D2 [those for the second line to be printed]
Set 3: Mask positions A3, B3, C3, D3 [those for the third line to be printed]

The term “printhead size” refers to the number of nozzles contained in the printhead. This term usually refers to the number of nozzles no capable of printing one color and is generally configured in a linear or rectangular formation such as that necessary to define 1-2 columns of nozzles.

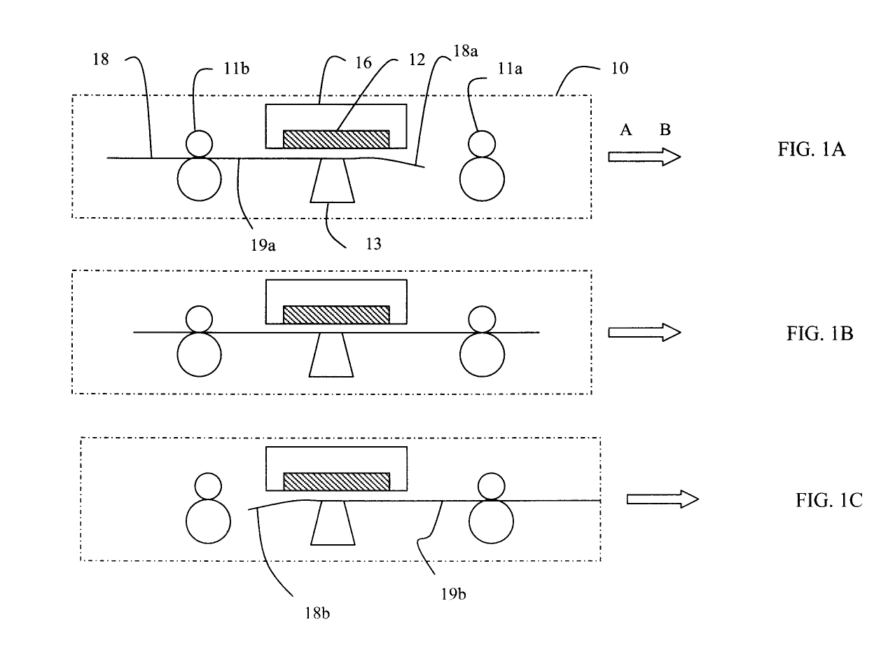

FIG. 1, shows a printer 10 having an inkjet printhead 12 with dot forming elements that include devices such as nozzles (not shown) mounted on carriage 16 facing the recording medium, and also referred to generically as a page, paper, media, or receiver 18, also referred to as a substrate. Carriage 16 is coupled through a timing belt and a driver motor (not shown) so as to be reproducibly movable back and forth in a direction perpendicular to the movement (shown by arrow A-B) of the recording medium 18. It will be understood that for a printer having multiple different color inks that there may be multiple printheads similar to that described for printhead 12. The different color printheads are arranged on a carriage 16 that traverses across the receiver sheet for a print pass. The nozzles in each of the color printheads, are actuated to print with ink in their respective colors in accordance with image instructions received from a controller or image processor using the various print masks described below.

As the substrate moves through the printer, it moves through different regions, as shown in FIGS. 1A, 1B and 1C. In FIG. 1A, a leading portion of the paper 18 is held by roller set 11b, but the leading edge 18a has not yet reached roller set 11a. Another leading portion of the paper 18 is supported by rib structure 13. However, the leading edge 18a which has passed rib structure 13 but has not yet arrived at roller set 11a, may deviate somewhat in its straightness. As a result, both the paper advance accuracy and the printhead 16 to paper 18 distance in this region may not be well controlled. By comparison, in FIG. 1B, the paper 18 is held by both roller sets 11a and 11b, so that paper motion and printhead to paper distance are well controlled. There is a transition region located approximately at point 19a in FIG. 1A, such that when point 19a is located under printhead 12, the paper begins to be held by both sets of rollers. Correspondingly, FIG. 1C shows another transition region near the trailing end 18b of the paper, such that when point 19b passes from beneath printhead 12, the paper 18 is no longer being held by roller set 11b, so that again the paper advance accuracy and the printhead to paper distance are not well controlled, as in FIG. 1C. In general, one or more transition positions 19 may be defined, for example, between the leading edge and the middle region, and also between the middle region and the trailing edge.

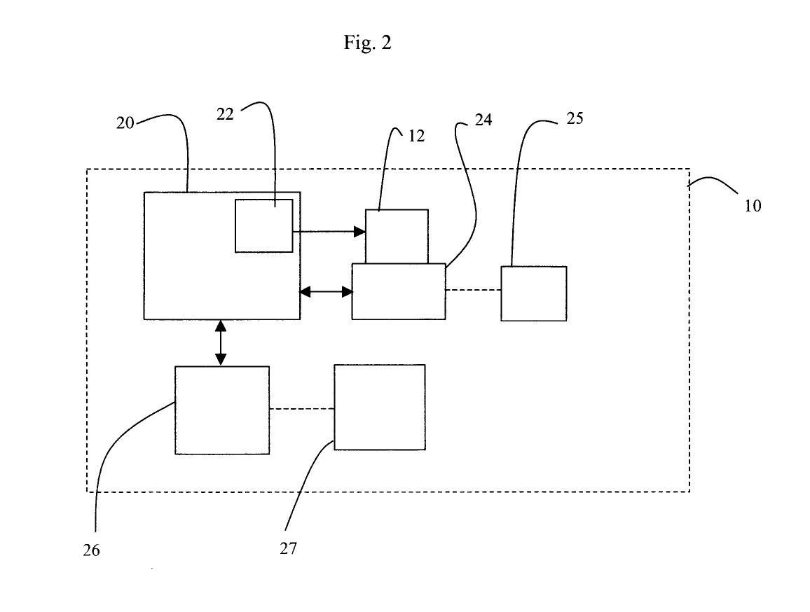

FIG. 2 shows a schematic of printer control features including a print mask to control nozzle operations. The inkjet printer 10 shown has a controller 20 including a print mask 22 to determine which nozzles of printhead 12 should be used to print each potential dot location on the receiver medium. Also shown are carriage motion controller and driver 24, carriage motor 25 media advance controller and driver 26, and media advance motor 27. The controller 20, which may include one or more microcomputers is suitably programmed to provide signals to the carriage motion controller and driver 24 that directs the printhead carriage drive to move the printhead. While the printhead is moving, the controller uses the print mask 22 to direct the printhead to eject ink drops onto the receiver medium 18 at appropriate pixel locations of a raster. Pixels on the raster are selectively printed in accordance with image signals representing print or no print decisions for each pixel location and/or pixel density gradient or drop size for each pixel location. The controller 20 may include a raster image processor, which controls image manipulation of an image file, which may be delivered to the printer via a remotely located computer through a communication port. Memory in the printer may be used to store the image file while the printer is in operation. Thus as noted above the printer may include a number of printheads or nozzle arrays, each for a different color. Preferably the printer includes enough printheads or nozzle arrays to print three or more different color inks.

The bitwise print mask 22 contains a row of Boolean data per nozzle in the printhead 12. The height H of the mask is less than or equal to the number of nozzles in the printhead. The value in each position of the mask is logically ANDed with the image data to determine whether to eject a drop at each location. Each mask row may contain 1 or more columns C. If the mask is narrower than the width of the image being printed, the mask is tiled across the image. The mask is divided into N sections, where N is the number of print passes to be performed on the image, and N is at least 1. The height of each section SH is the same, calculated as SH=H/N. The value of H must be picked such that SH is a whole integer number. The value SH is also the number of lines that the page is advanced after each carriage pass or swath. The corresponding nozzles within each mask section are known as complementary nozzles. The complementary nozzles are the ones that print a single row of the image as the page is advanced.

Below is a diagram showing the structure of a simple 4-pass print mask. In this example H=12, N=4, SH=3, C=1. In this and subsequent examples, the printhead is assumed to have 12 nozzles. For typical printers, the actual number of nozzles is usually several hundred or more, and the mask height H will also be correspondingly much greater than 12. Dotted lines in the diagram represent the boundaries between mask sections.

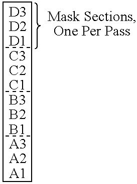

A section letter and a number (i.e. the mask layout identifiers) denote the positions in the mask. The data values at each position can be either a 0 or 1. In this example, there are three sets of complementary nozzles:

Set 1: Mask positions A1, B1, C1, D1

Set 2: Mask positions A2, B2, C2, D2

Set 3: Mask positions A3, B3, C3, D3

Here the complementary nozzles are the ones that will fall on the same line of the output print when the media is advanced for each successive swath. The print mask is mapped onto the printhead as shown in the next diagram. Note that the printhead may have more nozzles than the print mask has entries.

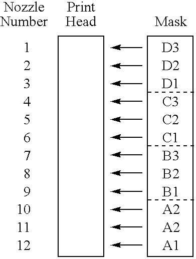

For example, the following is a 4-pass print mask that can lay down 1 drop per pixel:

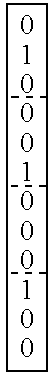

It would map onto the print head as follows:

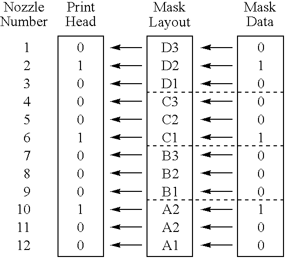

As shown in FIG. 3, the printhead 12 is advanced relative to the page 18 at the end of each swath. Actually it is the substrate that is being moved, but for simplicity of representation, the figures are drawn as if the printhead is moving in the opposite direction than the substrate is actually being moved. This example shows a 4-pass 12-nozzle mask. The mask layout identifiers are shown in the printhead. Note in the figure that the mask is shown as moving with the printhead. In other words, in FIG. 3, mask position A1 is always associated with nozzle 12, A2 is always associated with nozzle 11, etc. This is the case for normal multi-pass printing. This diagram shows how the printhead moves in relation to the page from swath to swath for purposes of illustration, but does not imply that the printhead is moving in that direction. In this figure it can be seen how the complementary nozzles line up with each other on any given line of the output.

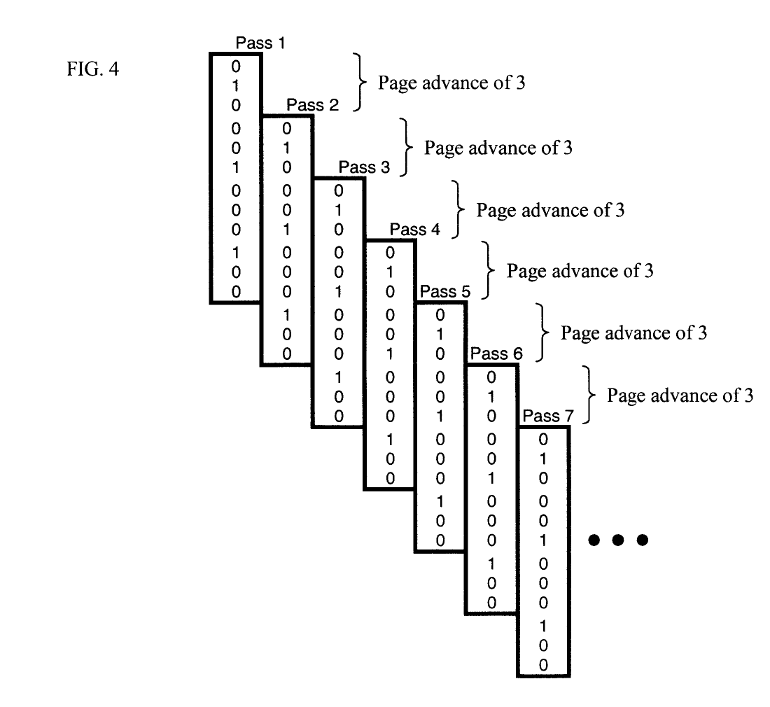

The mask is tiled across the width of the image. For example, if a print mask had a width of 4, the first column of the image data would be applied against the first column of the print mask. The second column of the image data would be applied against the second column of the print mask, and so on. The fifth column of the image would be applied against the first column of the print mask, as the mask is tiled. FIG. 4, discussed below, shows the same mask as in FIG. 3, but with the mask data shown in the printhead, rather than the mask layout identifiers.

In order to handle printing of multiple drops per pixel location, the mask may contain more than one plane or layer. The number of drops to be printed at each location is used to determine which plane of the mask to use for that location. The first plane of the mask is used to print at locations where there will be one drop. The second plane of the mask is used to print at locations where there will be two drops, and so on up to the number of planes in the mask. When the input image data is zero, no drop ejection is called for, and there is nothing to look up in the print mask. A mask may contain up to N planes, where N is the number of print passes to be performed on the image, and N is at least 1. Plane P of the mask, where 1<=P<=N, has complementary nozzle data that adds up to the value P.

The following diagram shows the contents of a print mask following the above rules. In this example H=12, N=4, SH=3, C=1, P=4. There are 4 planes of data in the print mask. Adding the complementary nozzles of each plane together, the total for each complementary nozzle set is equal to the plane number.

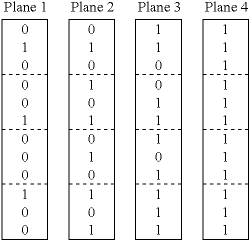

The use of this type of multi-plane print mask follows the same sequence of printing as does the previous examples, with one change: The value of the input pixel at each location will determine which plane of the print mask is used for determining whether to output a drop at that location. The use of a multi-planed print mask is described more fully in U.S. patent application Ser. No. 11/362,346 entitled “MULTI-LEVEL PRINTING MASKING METHOD”, filed on Feb. 24, 2006 by Eastman Kodak, and identified as attorney docket 91871, in the names of Steven A. Billow, Douglas W. Couwenhoven, Richard C. Reem, and Kevin E. Spaulding, the contents of which are fully incorporated by reference as if set forth herein.

In this description there is reference to two types of masks used during printing, shifted and normal, which are defined as follows:
a shifted mask is one that has been shifted vertically for use in one of the preload passes. The shifted masks are also shorter in the vertical direction—the shifted mask has a height equal to the page advance distance times the pass number.
a normal mask has its contents in the original position.

Continuing with the description of the present invention, a few more terms and concepts will now be introduced. A “preload” pass is now defined wherein the print mask is shifted by a number of nozzle positions relative to the printhead. Preload passes are used in situations where multipass printing is desired, but it is advantageous to keep the page stationary. Examples of this situation commonly occur at the top and bottom of a “borderless” print, in which it is desired that ink is deposited right up to the edge of the page, with no unprinted border surrounding the printed area. It is known in the art that in borderless print modes, it is advantageous to keep the media stationary at a position in the printer where the flatness of the paper surface can be maintained, thereby providing improved print quality. For example, U.S. Pat. No. 5,555,006 discusses “sweep rotation” of the mask near the top and bottom of the page (see section 6 of '006). Sweep rotation of a mask is substantially the same as the concept of preloaded passes described herein. However, '006 discloses only the use of sweep rotation of the mask for facilitating the printing of the top edge and the bottom edge of the paper. Patent '006 does not disclose the compensation for failed nozzles at the top and bottom edges of the paper, which is an object of the present invention.

Depending on the number of preload passes, the number of total passes, and the number of drops being printed per location it may not be possible to compensate for all the missed drops, but the system described below will provide an excellent print even when that situation occurs. In many borderless printing methods which keep preload pass position absolutely still, it is sometimes difficult to compensate for all missing drops, and since compensated drops are fired at limited passes and nozzles, there may not be enough randomization to hide character of individual nozzle. Cases where the complementary nozzles picked also fail can make this situation even worse. The system and method described below overcome the print errors that these problems present.

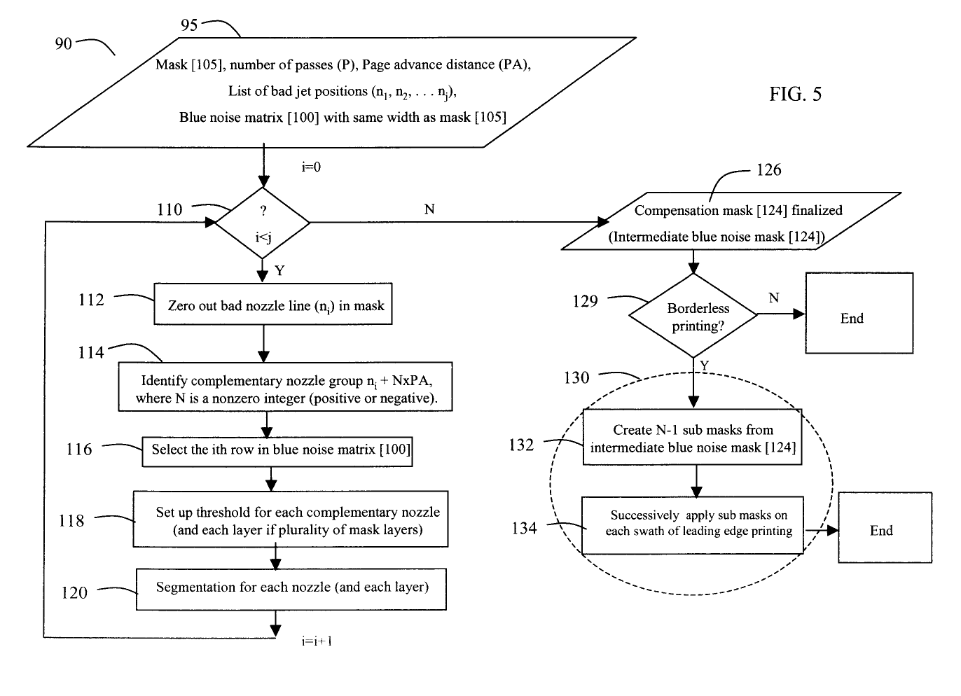

To solve these problems seen in the prior arts, an alternative method for compensating for failed nozzles was developed utilizing blue noise intermediate mask creation as described below. In the following discussion of embodiments of the invention, borderless printing near the lead edge of the image receiver is described. Similar methods would also be applicable near the trail edge of the image receiver. An embodiment of a general method 90 of creating a blue noise intermediate mask and using it for compensation of failed nozzles is shown in the flowchart of FIG. 5. Steps 132 and 134 (denoted as set of steps 130) in the flowchart show the extension of the method to the case of compensation for failed nozzles for borderless printing. The borderless method alters a print mask for a print head supporting a plurality of nozzles arranged in sections in relation to an image receiver path with an image receiver edge to prevent artifacts.

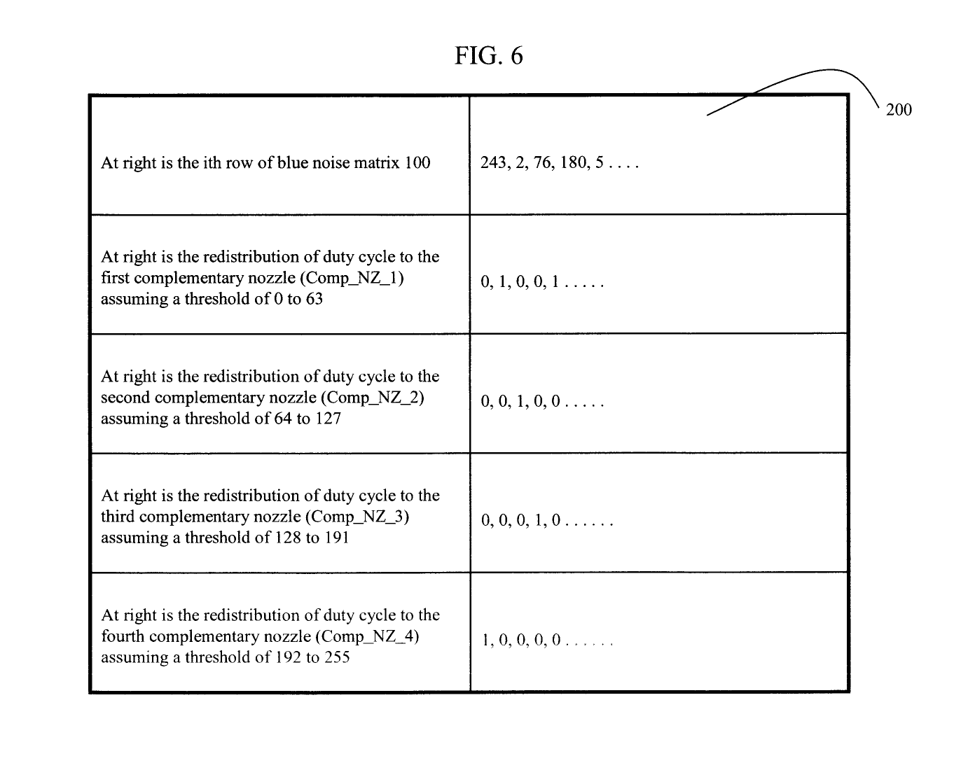

At the initial step 95 of the flowchart of FIG. 5, mask 105 is input, together with the number of passes P for the desired print mode, and the page advance distance PA corresponding to that print mode. In addition a list of bad jet positions (nᵢ, n₂ . . . nⱼ) is specified, where j is the number of bad jets. A blue noise matrix 100, having the same width as mask 105, is provided as a table of numbers (from 0 to 255, for example) in somewhat random order. Then an iterative process (steps 110 through 120) is carried out j times. Initially i is set equal to 0. At step 110 if i<j, the iterative process continues. If i=j, the process is done and compensation mask 124 is the result. In other words, if j=0 (no bad nozzles) the compensation mask 124 is the same as the initial mask 105. However, if there is a bad nozzle, then at step 112, row nᵢ in mask 105 (corresponding to the bad nozzle) is set to zero, thereby disabling the printing of the bad nozzle. At step 114, all of the complementary nozzles to that bad nozzle are identified as satisfying the condition nᵢ+N×PA, where N is a positive or negative integer such as −2, −1, 1 and 2, and where the number of different values of N is P−1 (one less than the number of passes). At step 116, row i in the blue noise matrix 100 is selected. In step 118, this row is used to set a threshold for each complementary nozzle, as will be described in more detail below in relation to FIG. 6. Segmentation for each nozzle is performed at step 120. For the case of print modes where there are multiple drops per pixel locations, steps 118 and 120 are modified to include setting up a threshold for each mask layer, and segmentation for each mask layer respectively.

FIG. 6 shows an example of steps 116, 118 and 120, in which the blue noise matrix 100 is used together with a threshold set up for each complementary nozzle to provide segmentation for each nozzle (and each mask layer for the case of multiple drops per pixel location). Blue noise matrix 100 consists, for example of the numbers 0 to 255 arranged in a table of rows and columns, where the number of columns is the same as the number of columns in mask 105. At step 116 row i of the blue noise matrix is selected. In the example shown in FIG. 6, this row is denoted as 200. The example of FIG. 6 corresponds to 5 pass printing with one failed nozzle. Thus there are four complementary nozzles (Comp_NZ_1 to Comp_NZ_4) for the failed nozzle. In FIG. 6 the duty cycle for printing that had previously been assigned to the failed nozzle becomes shared among these four complementary nozzles in steps 118 and 120. In this example, the ith row 200 of blue noise matrix 100 begins 243, 2, 76, 180, 5. In this example, the thresholds are set in the follow way: Complementary nozzle 1 has a threshold of 0 to 63; complementary nozzle 2 has a threshold of 64 to 127; complementary nozzle 3 has a threshold of 128 to 191; and complementary nozzle 4 has a threshold of 192 to 255. If the mth value in the ith row 200 of blue noise matrix 100 falls within the threshold range of a given complementary nozzle, then the mth value in the compensation mask 124 corresponding to that nozzle becomes a 1: if not, it becomes a 0. For example, the first value in the ith row 200 happens to be 243, which falls within the threshold range of Comp_NZ_4, so the first mask value for this complementary nozzle is 1, but the first mask value of all of the other complementary nozzles is 0.

In the previous paragraph, it was assumed that there was only one drop per pixel location, i.e. a single mask plane or layer. If there are two drops per pixel location, the segmentation is done in a similar way. However, the mask values relative to one of the two drops per pixel is thresholded relative to one portion of the blue noise matrix 100, and the mask values relative to the other of the two drops per pixel are thresholded relative to a different portion of the blue noise matrix 100. In that way, the selection of which complementary nozzle is to print the first of the two drops for a given pixel location is independent of the selection of which complementary nozzle is to print the second of the two drops.

After step 120 in the flowchart of FIG. 5, i is incremented by 1 and the process goes back to step 110 to see if i is still less than j. In this way, steps 110 through 120 are repeated a total of j times (once for each bad nozzle). At the end of repeating the steps j times, at step 126, the different rows of compensation mask 124 will have been finalized. All rows corresponding to failed nozzles will have been set to 0, while rows corresponding to complementary nozzles to a failed nozzle will have been changed to include a shared responsibility to print on behalf of the failed nozzle, where the shared responsibility will have been somewhat randomized by use of the blue noise matrix.

At step 129 it is determined whether the region to be printed requires borderless printing. If borderless printing is required, then the steps enclosed in dotted line oval 130 must also be done. In that case, the “finalized compensation mask” 124 is not the mask used to control printing, but 124 is then an intermediate mask (referred to herein as an intermediate blue noise mask 124) which needs to be further modified. At step 132, N−1 sub masks are created from intermediate blue noise mask 124, where the data in each successive sub mask is shifted through the mask and each successive sub mask has one page-advance number of rows fewer than the previous sub mask. For example, suppose that mask 105 and intermediate blue noise mask 124 each have 640 rows (corresponding to a 640 nozzle printhead), and further suppose a 5 pass print mode is used, corresponding to a page advance of 128 nozzle spacings. Then in the borderless printing region, the first sub mask will have 640−128=512 rows; the second sub mask will have 640−2(128)=384 rows; the third sub mask will have 640−3(128)=256 rows; and the fourth sub mask will have 640−4(128)=128 rows. At step 134, it is these sub masks that are applied on each swath of leading edge printing, for example, for borderless printing.

As discussed above in connection with FIG. 1A, when printing is required near the leading edge of the paper (as in borderless printing), the paper is not held well in that region so that paper advance distance and printhead to paper spacing may not be well controlled. In order to minimize image discontinuities at swath boundaries, it is preferable to advance the receiver medium only a small amount between swaths in this region of printing. For example, for a print mode employing five-pass printing using a printhead with 640 nozzles per color, the normal page advance (not near the borderless printing region) will be set to approximately 128 pixel spacings, corresponding to a fifth of the nozzles in that nozzle array of the printhead. (The page advance may be set to slightly less than 128 nozzle spacings, if some nozzles at the ends are not used or are reserved for overlap, for example.) By contrast, the page advance in the borderless region may be set to a “micro-movement” amount of 8 pixel spacings (i.e. 8 raster line spacings), for example. In this example of a 128 pixel spacing page advance for the five-pass mode away from the edge of the receiver medium, and an 8 pixel spacing micro-movement page advance within the borderless printing region near the edge of the receiver medium, while the printhead moves relative to the paper by 8 pixel spacings, the mask “moves” by 128+8=136 pixels. Thus, even in the borderless printing regions bad nozzles may be compensated for by providing randomization and by sharing the printing duty cycle among a number of nozzles. In this example, we chose 8 pixel spacings for the micro-movement, but other small spacings could have been chosen. Eight pixel spacings corresponds to 8/640=1/80 of the full nozzle array length of the printhead of the example. Typically a micro-movement distance in the borderless printing region will be between about 0.5% and 5% of the full length of the nozzle array in the printhead.

In this method of mask data shifting, micro-movement, randomization and duty cycle sharing, an adequate amount of compensation for failed nozzles is provided without the need to recreate the mask for each swath, so there is not a heavy demand on system resources such as memory and cpu time. Therefore compensation may be done on the fly while printing without slowing down print speed. It should be noted that failed nozzles are not compensated 100% in this embodiment corresponding to the flowchart in FIG. 5. The degree of Compensation is closer to 80% in this embodiment (assuming that the number of failed nozzles is much less than the number of good nozzles), but in most cases that is satisfactory because the missing pixels are small and somewhat isolated. The compensation is not 100% near the edges of the image receiver, because there are not enough passes available with complementary nozzles to fully compensate for the failed nozzle.

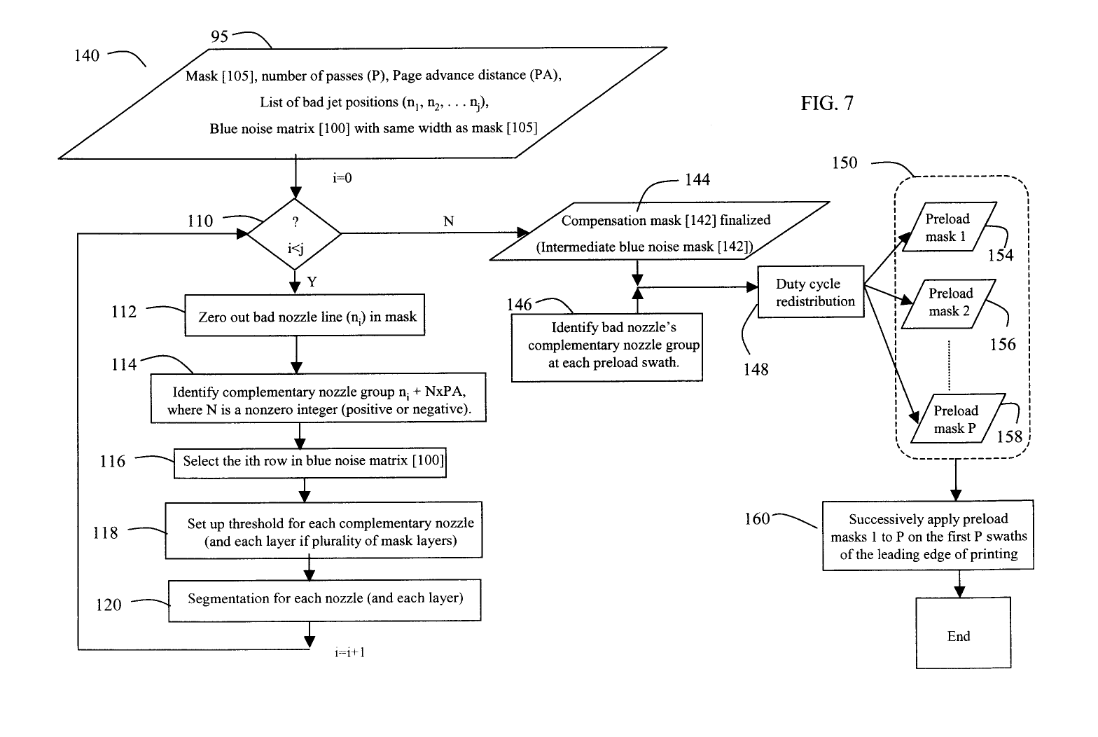

An embodiment of a general method 140 for a fuller degree of compensation for failed nozzles is outlined in the flowchart of FIG. 7. Steps 95 through 120 on the left hand side of the FIG. 7 flowchart are identical to the similarly numbered steps on the left hand side of FIG. 5. The resulting finalized compensation mask 142 (for the non-borderless printing region) or the intermediate blue noise mask 142 in step 144 are thus formed in the same way as masks 124 in the flowchart of FIG. 5. For borderless printing, in step 146, for each bad nozzle, the complementary nozzle group is identified at each preload pass. Duty cycle redistribution 148 uses both the intermediate blue noise mask 142 and the identified complementary nozzle groups 148. The group 150 of masks for preload passes 1 to P includes preload mask 1 (154), preload mask 2 (156), and so on up through preload mask P (158). Each preload pass mask is created individually, requiring increased demands on system resources, but also enabling full compensation for failed nozzles. At each preload pass, the mask values mapping to the printhead nozzle array are shifted by an amount corresponding to the amount of micro-movement page advance (such as 8 pixel spacings, for example). Then, for each failed nozzle in the printhead, first the row of the print mask corresponding to that nozzle is found. Each column of that row is examined (for each plane of the mask). Wherever a 1 is found in a column of the row corresponding to the failed nozzle, the complementary nozzles to that position are scanned for 0 values. One of those 0 values is then set to 1, and the entry in that column for the failed nozzle is set to 0. This will cause the drop that would have been fired by the failed nozzle to be fired on a different pass instead.

To illustrate how the preload pass masks have different content rather than simply having shifted content as in the process outlined in the flowchart of FIG. 5, suppose preload pass mask 1 at step 154 has row 5 set to 0 corresponding to a failed nozzle in the printhead, and the duty cycle redistributed from row 5 to complementary nozzles further down in nozzle array which have not yet been passed by the corresponding line on the image receiver. Then after micro-moving by 8 pixel spaces, in preload pass mask 2 at step 156, row 13 will be set to zero, and the duty cycle redistributed among a smaller set of complementary nozzles which have not yet been passed by the corresponding line on the image receiver. In this way, greater certainty is provided that the complementary nozzles will compensate for the failed nozzles. However, at the extreme edges of the print, it is possible that not enough passes are made to enable 100% compensation.

In the exemplary embodiment outlined in the flowchart of FIG. 5, for each print mode, after locations of failed jets have been identified and the intermediate blue noise masks 124 corresponding to each print mode have been created, these masks 124 may be stored in permanent memory and then used to directly for normal printing, as well as to create on the fly sub masks (step 132) as needed for borderless printing. This requires a modest amount of permanent memory allocation but enables higher printing speed. In fact, the sub masks themselves may be stored in permanent memory, although their creation by shifting is so simple, that this extra use of memory may not be warranted. The sub mask would be stored temporarily until it is used and then the memory allocation for it would be released. For the exemplary embodiment outlined by the flowchart in FIG. 7, the amount of memory required as well as computational time for generating the preload masks is increased, and a different set of tradeoffs of temporary vs permanent storage of intermediate and/or preload masks may be made.

The invention has been described in detail with particular reference to certain preferred embodiments thereof but it will be understood that variations and modifications can be effected within the spirit and scope of the invention. This invention is inclusive of combinations of the embodiments described herein. References to a “particular embodiment” and the like refer to features that are present in at least one embodiment of the invention. Separate references to “am embodiment” or “particular embodiments” or the like do not necessarily refer to the same embodiment or embodiments; however, such embodiments are not mutually exclusive, unless so indicated or as are readily apparent to one of skill in the art. The use of singular and/or plural in referring to the “method” or “methods” and the like are not limiting.

1. A method for borderless printing for a print head supporting a plurality of dot forming elements to prevent artifacts, the method comprising the steps of:
a. creating an intermediate print mask having one or more intermediate print sections by defining a print mask subset wherein the subset is defined based on the print head location relative to an edge of an image receiver;
b. creating an altered print mask having a plurality of mask sections by shifting each intermediate print section along an image receiver movement axis by a micro-movement amount equal to a whole number of raster lines sufficient to locate another dot forming element to print for a dot forming element including any number of disabled dot forming elements;
c. moving the image receiver relative to the print head by the micro-movement amount; and
d. printing using the altered print mask.

2. The method according to claim 1, the plurality of dot forming elements arranged in an array having a length, the micro-movement step further comprising image receiver movement a distance that is between 0.5% and 5% of the array length in a page advance direction.

3. The method according to claim 1, further comprising storing the intermediate print mask or the altered print mask in temporary memory to save memory.

4. The method according to claim 1, further comprising storing the intermediate print mask or the altered print mask in permanent memory to speed up printing.

5. The method according to claim 1, wherein the subset is further defined based on the location of one or more disabled dot forming elements.

6. The method according to claim 1, the step of creating an intermediate print mask including the steps of setting a row corresponding to a disabled (lot forming element equal to zero, and using a blue noise mask to reassign printing duty cycle from the bad dot forming element to dot forming elements that are complementary to the bad nozzle.

7. The method according to claim 1, the print head further comprising an inkjet print head.

8. The method according to claim 1, the altered print mask including a number of rows, wherein the number of rows is less than the number of dot forming elements.

9. A print mask control device for selection of dot forming elements in a print head when the print head approaches an image receiver edge in an image receiver movement path comprising:
a. a controller, responsive to image data representing the image and an image receiver location, the controller configured to alter a print mask table that stores mask data values that determine whether or not each dot forming element is actuated at a respective pixel location on the reference raster during a respective printing pass; and
b. an altered mask such that mask data corresponding to at least one set of dot forming elements is activated or deactivated in response to image receiver location; and
an image receiver movement device that advances the image receiver a micro-movement along an image receiver movement axis as the print head passes the image receiver edge wherein the micro-movement amount is sufficient to locate another dot forming element to print for a dot forming element including any number of disabled dot forming elements.

10. The movement device according to claim 9, wherein the dot forming elements are arranged in an array having a length, and the image receiver micro-movement amount is a distance that is between 0.5% and 5% of the array length in a page advance direction.

11. The control device according to claim 9, wherein image receiver is advanced at a first distance prior to passing a transition position, and switching to a second image receiver advance distance after the print head has moved past the transition position.

12. A method for compensating for bad dot forming elements on a print head supporting a plurality of dot forming elements arranged in complementary dot forming element groups by section, to prevent artifacts in printing on an image receiver, the method comprising the steps of:
a. identifying each bad dot forming element;
b. zeroing out the corresponding bad dot forming element line (nⱼ) in a mask;
c. identifying and setting up a threshold for each complementary dot forming element group corresponding to one or more bad dot forming elements;
d. creating a compensation print mask having one or more intermediate print sections by using one or more rows of a blue noise matrix and the thresholds for the complementary dot forming elements to reassign printing duty cycle from the bad dot forming elements to the respective complementary dot forming elements; and
e. printing using the compensation print mask.

13. The method according to claim 12, further comprising not altering the compensation print mask for printing in a region where the image receiver is contacted by more than one set of rollers.

14. The method according to claim 12, wherein using the compensation print mask comprises using the compensation print mask as an intermediate mask which is subsequently altered for printing in a region where the image receiver is not contacted by more than one set of rollers.

15. The method according to claim 14, wherein the image receiver, when it is not contacted by more than one set of rollers, is moved by a micro-movement page advance distance which is much less than the image receiver is moved in a region where it is contacted by more than one set of rollers.

16. The method according to claim 15, wherein the micro-movement page advance distance comprises a movement distance that is between 0.5% and 5% of a length in a page advance direction.

17. The method according to claim 14, wherein the altering of the intermediate mask comprises successively shifting mask data in the intermediate mask as part of the process of forming successive sub masks to be used in the region where the image receiver is not contacted by more than one set of rollers.

18. The method according to claim 14, wherein the altering of the intermediate mask comprises individually modifying the intermediate mask to from each altered mask to be used in the region where the image receiver is not contacted by more than one set of rollers.

19. The method according to claim 14, wherein the image receiver is advanced at a first distance prior to passing a transition position, and switching to a second image receiver advance distance after the print head has moved past the transition position.

20. The method according to claim 14, further comprising storing the compensation print mask in temporary memory.
